(19) United States
(12) Patent Application Publication
(10) Pub. No.: US 2008/0154808 A1
(43) Pub. Date: Jun. 26, 2008

(54) Use and construction of time series interactions in a predictive model

(75) Inventor: Matthew V. Grieco, Somerville, MA (US)

Correspondence Address: BACHMAN & LAPOINTE, P.C., 900 CHAPEL STREET, SUITE 1201, NEW HAVEN, CT, 06510, US

(73) Assignee: Genalytics, Inc.

(21) Appl. No.: 11/584,297

(22) Filed: Oct. 20, 2006

(51) Int. Cl. G06N 3/12

(52) U.S. Cl. 706/13

(57) ABSTRACT

A gene is disclosed for use in a predictive genetic algorithm that performs time series interactions between dataset variables. The temporal logic that performs the interaction is encoded as a binary string.

### BACKGROUND OF THE INVENTION

The invention relates generally to the field of genetic algorithms. More specifically, the invention relates to methods for implementing time series interactions using temporal selection genes.

Genetic algorithms are useful in solving optimization problems, scheduling problems and function-approximation problems and are currently used in,chemistry, medicine, computer science, economics, physics, engineering design, manufacturing systems, electronics and telecommunications and various related fields. Custom computer applications are now commonplace in a wide variety of fields, and are in use by a majority of Fortune 500 companies to solve difficult scheduling, data fitting, trend spotting and budgeting problems, prediction, and virtually any other type of combinatorial optimization problem.

Genetic algorithms are stochastic search algorithms that use techniques inspired by evolutionary biology such as inheritance, mutation, selection, and crossover which is also known as recombination. A typical genetic algorithm requires a genetic representation of solutions and a fitness function to evaluate them.

Genetic algorithms are based on the same principle as that of natural evolution. Members of a population in artificial evolution represent the candidate solutions. The problem itself represents the environment. Every candidate solution is applied to the problem and a fitness value is assigned for every candidate solution depending upon the performance of the candidate solution on the problem. In compliance with the theory of natural evolution, more adaptive or fitter hereditary traits are carried over to the next generation. The features of natural evolution are maintained by ensuring that the reproduction process preserves many of the traits of the parent solution and yet allows for diversity for exploration of other traits. The fitness of a candidate is measured by the success of the candidate's life.

Genetic algorithms operate on a set of candidate solutions which are generated randomly or probabilistically at the beginning of evolution. This set of candidate solutions are generally bit streams called chromosomes as shown in FIG. 1. The set of current chromosomes is termed a population. Genetic algorithms operate iteratively on a population of chromosomes, updating the pool of chromosomes at every epoch or iteration. For each epoch, all the chromosomes are evaluated according to the fitness function and ranked according to their fitness values. The fitness function is used to evaluate the potential of each candidate solution. The chromosomes with higher fitness values have higher probability of containing more adaptive traits than the chromosomes with lesser fitness values, and are more fit to survive and reproduce. A new population is then generated by probabilistically selecting the most fit individuals from the current population using a selection operator. Some of the selected individuals may be carried forward into the next generation intact to prevent the loss of the current best solution. Other selected chromosomes are used for creating new offspring individuals by applying genetic operators such as crossover and mutation. The end result of this process is a collection of candidate solutions which contain members that are often better than the previous generations.

In order to apply a genetic algorithm to a particular search, optimization, or function approximation problem, the problem must be first described in a manner such that an individual will represent a potential solution and a fitness function which evaluates the quality of the candidate solution must be provided. The initial potential solutions (population) are generated randomly and then the genetic algorithm makes this population more adaptive by means of selection, recombination and mutation as shown in FIG. 2. FIG. 2 shows a simple genetic algorithm framework which may be applied to most search, optimization and function approximation problems with slight modifications depending upon the problem environment. The inputs to the genetic algorithm specify the population size to be maintained, the number of iterations to be performed, a threshold value defining an acceptable level of fitness for terminating the algorithm, and the parameters to determine successor populations.

To apply genetic algorithms to any problem, the candidate solutions must be encoded in a suitable form so that genetic operators are able to operate in an appropriate manner. Generally, the potential solution of the problem is represented as a set of parameters encoded as chromosomes. As shown in FIG. 1, solutions are represented in binary as strings of 1's and 0's, but different encodings are also possible. Each bit in the string can represent some characteristic of the solution.

Binary encodings are used due to their simplicity and ease with which the genetic crossover and mutation operators can manipulate the binary encoded bit streams. Integer and decision variables are easily represented in binary encoding. Discrete variables can also be easily encoded as bit strings. The easiest way to encode any feature into a bit stream is to use a bit string of length N, where N is the number of possible values a particular feature or gene may have.

Continuous values are harder to encode into binary strings. In some cases continuous values are discretized by classifying the values into classes. In some cases continuous values are encoded directly into binary strings by converting the number into a binary format. However, to maintain fixed length strings, the precision of continuous values is restricted.

Binary encodings are used in feature subset selection tasks. In a feature subset selection task, the aim is to find an optimal combination of subset of features from a set of candidate features. A binary encoding can be used to represent the subset of features. The chromosome is a binary string of length equal to the number of candidate features. A 0 in bit position n in the chromosome represents that the corresponding feature is not included in the subset of features, whereas a 1 in bit position n represents that the corresponding feature is included in the subset of features.

The standard representation is an array of bits. Arrays of other types and structures may be used in essentially the same way. The main property that makes these genetic representations convenient is that their parts are easily aligned due to their fixed size that facilitates simple crossover operation. Variable length representations may also be used, but crossover implementation is more complex.

The simplest algorithm represents each chromosome as a bit string. Typically, numeric parameters can be represented by integers, though it is possible to use flointing point representations. The basic algorithm performs crossover and mutation at the bit level. Other variants treat the chromosome as a list of numbers which are indexes into an instruction table, nodes in a linked list, hashes, objects, or any other imaginable data structure. Crossover and mutation are performed so as to respect data element boundaries. For most data types, specific variation operators can be designed. Different chromosomal data types seem to work better or worse for different specific problem domains.

The fitness function ƒ(x) is defined over the genetic representation and measures the quality of the represented solution. The fitness function is always problem dependent. Once the genetic representation and the fitness function is defined, the algorithm proceeds to initialize a population of solutions randomly, then improves it through repetitive applications of mutation, crossover, and selection operators.

The population size depends on the nature of the problem, but typically contains several hundreds or thousands of possible solutions. Traditionally, the population is generated randomly, covering the entire range of possible solutions known as the search space.

During each successive epoch, a proportion of the existing population is selected to breed a new generation (steps 205-210). Individual solutions are selected through a fitness-based process, where fitter solutions as measured by the fitness function ƒ(x) are more likely to be selected. The fitness function ƒ(x) is specific to a problem domain and varies from implementation to implementation. For example, in any classification task, the fitness function typically has a component that scores the classification accuracy of the rule over a set of provided training examples. The value assigned by the fitness function also influences the number of times an individual chromosome is selected for reproduction. The candidate solutions are evaluated and ranked in descending order of their fitness values. The solutions with higher fitness values are superior in quality and have more chances of surviving and reproducing.

A fitness function ƒ(x) quantifies the optimality of a solution. It evaluates all the candidate solutions and evaluates the quality of all individual solutions. It gives a criterion to rank candidate solutions which is the basis of making a decision as to whether a particular individual solution is fit to survive and reproduce. A fitness function ƒ(x) must be devised for each problem. The fitness function takes in one chromosome at a time as input and returns a single numeric value, which is indicative of the ability or utility of the candidate solution represented by the input chromosome. The fitness function ƒ(x) should be smooth and regular so that there is not much disparity in the fitness values of chromosomes. An ideal fitness function ƒ(x) should neither have too many local maxima, nor a very isolated global maximum. The fitness function should correlate closely with the algorithm's goal, and should be executed quickly, as genetic algorithms must be iterated numerous times to produce useful results. For example, if the task is to learn classification rules, then the function has a component that scores the classification accuracy of the rule over a set of training examples.

After the candidate solutions are ranked, the next step is to generate a second generation population of solutions. The selection process selects some of the top solutions probabilistically (step 220). A certain number of chromosomes from the current population are selected for inclusion in the next generation. Even though these chromosomes are included directly in the next generation, they are also used for recombination to achieve preservation of the adaptive traits of the parent chromosomes and also allow exploration of other traits. Once these members of the current generation have been selected for inclusion in the next generation population, additional members are generated using a crossover operator (step 225).

For each new solution to be produced, a pair of parent solutions is selected for breeding from the pool selected previously. By producing an offspring solution using crossover and mutation, a new solution is created which shares many of the characteristics of its parents. New parents are selected for each child, and the process continues until a new population of solutions of appropriate size is generated.

Various crossover operators may be used. An example is shown in FIG. 3. The crossover operator produces two new offspring from two parent strings by copying selected bits from each parent. The bit at position i in each offspring is copied from the bit at position i in one of the two parents. The choice of which parent contributes the bit for position i may be determined by an additional string called a crossover mask. After crossover, genetic algorithms often apply a mutation operator to the chromosomes to increase diversity (step 230). An example mutation is shown in FIG. 4. Mutation is intended to prevent early convergence of all solutions in the population into a local optimum of the solved problem. The mutation operator produces small random changes to the bit string by choosing a single bit at random, then changing its value as shown in FIG. 4.

The combined process of selection, crossover and mutation produces a new population generation (step 235). The current generation population is replaced by the newly generated population. Some individuals may be carried over. The new population becomes the current generation population in the next iteration (steps 220-240). These processes ultimately result in the next generation population of chromosomes that is different from the initial generation. Generally the average fitness will have increased by this procedure for the population, since only the best organisms from the first generation are selected for breeding, along with a small proportion of less fit solutions, for reasons already mentioned above. So, a random population generation is required only once, at the start of first generation, and otherwise the population generated in the n^{th} generation becomes the starting population for the (n+1)^{th} generation. The genetic algorithm process terminates at a specified number of iterations, or if the fitness value crosses a specified threshold fitness value (step 245). The outcome of a genetic algorithm is a set of solutions that have a fitness value significantly higher than the initial random population (step 250).

This generational process is repeated until a termination condition has been reached. Common terminating conditions are a solution is found that satisfies a minimum criteria, a fixed number of generations are reached, an allocated budget (computation time/money) is reached, or the highest ranking solution's fitness is reaching or has reached a plateau such that successive iterations no longer produce better results.

There is no guarantee that the solution obtained by a genetic algorithm is optimal, however, genetic algorithms will usually converge to a solution that is very good.

Since genetic algorithms are stochastic, iterative algorithms, the candidate solutions should get better with more iterations. Genetic algorithms attempt to preserve individuals with good traits (i.e., preserving individuals having high fitness values) and to create better individuals with new traits by combining fit individuals. Genetic algorithms employ genetic operators to preserve fit individuals (selection) and to explore new traits by recombining fit individuals (crossover and mutation). The function of a genetic operator is to cause chromosomes created during reproduction to differ from those of their parents in order to explore any missing traits. The recombination operators must be able to create new configurations of genes that never existed before and are likely to perform well.

At every iteration, chromosomes are recombined to create new chromosomes in an attempt to find better chromosomes. As genetic algorithms follow the theory of natural evolution, better individuals should be able to survive and reproduce. The selection operator is used to select fit individuals from the population for recombination. Before any recombination takes place, the fittest individual solutions are selected and promoted to the next generation in an attempt to ensure that the best solution is not lost. Then the selection operator is applied again for choosing chromosomes to act as parents and produce new offspring. The selection operator is solely responsible for choosing better individuals for preservation and recombination. The selection process is one of the key factors affecting the overall performance of the genetic algorithms. If the selection mechanism selects fit individuals for elitism and recombination, then the solution converges faster. The selection process controls which fit individuals should be preserved and which individuals should be used for recombination. A bad selection mechanism could hamper the performance of a genetic algorithm in terms of quality and also in terms of convergence rate.

Once a basic genetic algorithm is implemented, a new chromosome may be created to solve another problem. The same encoding may be used with only the fitness function changed. However, for some problems, the choosing and implementation of the encoding and the fitness function may be difficult.

Predictive modeling is the process by which a model, or equation, is created to best predict an outcome. Current methods of creating a predictive model include linear regression, logistic regression, and neural networks.

The input to all methods of creating a model is a dataset. A training dataset is used to build a predictive model and contains several independent variables and a single dependent variable. The independent variables are used in the body of the equation to predict the dependent variable. The goal in building a predictive model is to create an equation that maximizes the ability of correctly predicting the dependent variable in the training dataset using a subset of the independent variables in the training dataset.

Several tasks that must be performed when creating a predictive model include selecting a subset of the independent variables to use in the equation, determining the treatment of the variables used (i.e. missing value substitution, normalization, outlier trimming, and others), and searching for interactions between two independent variables. Discovering linear relationships between independent variables that are helpful in predicting an outcome is relatively easy when compared to discovering nonlinear or temporal relationships between variables.

An example of a nonlinear relationship would be exploring the effect of interacting a variable at several different points in time, such as the average account balance from February, March and April on predicting an outcome. Since there are many possible interactions to explore using a genetic algorithm as a tool, better results may be obtained faster than using other methods.

A need exists for a methodology to examine a specific variable in a dataset at several points in time in a predictive model and allow for normal evolution.

### SUMMARY OF THE INVENTION

Although there are various types of chromosomes capturing problem encoding, such chromosomes are not completely satisfactory. The inventor has discovered that it would be desirable to include genes that perform time series interactions between dataset variables. The temporal logic that performs the interaction is encoded as a binary string.

One aspect of the invention provides a temporal gene for use in a chromosome of a genetic algorithm. Genes according to this aspect of the invention comprise a series selection component for determining which series from a dataset will interact, a temporal selection component for determining a start location value and an end location value that map to variables in the selected series, and an operator selection component for determining which operator from a predefined list of operators will be used to interact with variables from the start location value to the end location value, wherein the temporal gene returns a result from the interaction between the operator and the variables from the start to the end locations.

Another aspect of the invention is a method of creating temporal interactions for use in a genetic algorithm as a temporal gene. Methods according to this aspect begin with providing a series selection component for determining which series from a dataset will interact, providing a temporal selection component for determining a start location value and an end location value that map to variables in the selected series, and providing an operator selection component for determining which operator from a predefined list of operators will be used to interact with variables from the start location value to the end location value, wherein the temporal gene returns a result from the interaction between the operator and the variables from the start to the end locations.

Yet another aspect of the invention is a method of creating temporal interactions for use in a genetic algorithm as a temporal gene. Methods according to this aspect begin with providing a series selection component for determining which series from a dataset will interact, providing a temporal selection component for determining a start location value and an end location value that map to variables in the selected series, providing an operator selection component for determining which operator from a predefined list of operators will be used to interact with variables from the start location value to the end location value, providing a coefficient gene for holding a predetermined value, assembling a logic for returning a result from the selected operator and the temporal selection component start and end location values, and multiplying the predetermined value with the result.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is an exemplary architecture of two parent chromosomes.

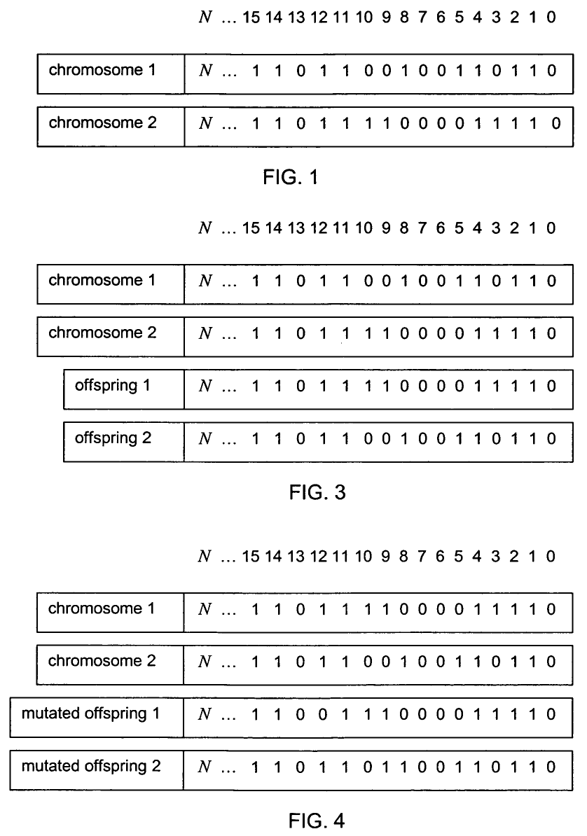

FIG. 2 is an exemplary block diagram of a method for a genetic algorithm.

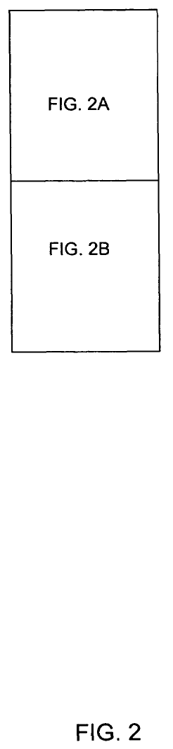

FIG. 3 is an exemplary crossover of the two parent chromosomes shown in FIG. 1.

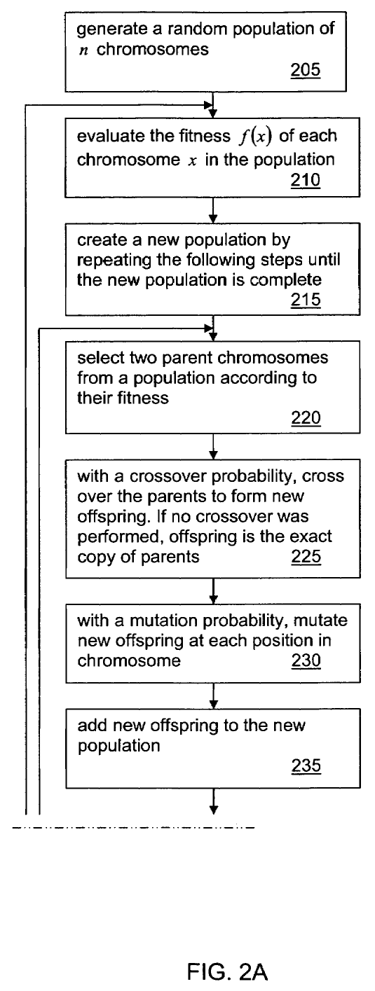

FIG. 4 is an exemplary mutation of the two parent chromosomes shown in FIG. 1.

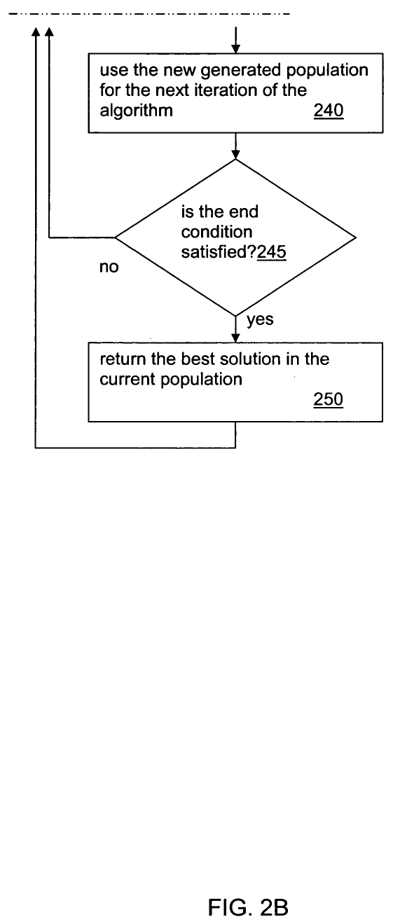

FIG. 5 is an exemplary temporal gene according to the invention.

FIG. 6 is an exemplary series selection component according to the invention.

FIG. 7 is an exemplary operator selection component according to the invention.

FIG. 8 is an exemplary temporal selection component start location according to the invention.

FIG. 9 is an exemplary temporal selection component end location according to the invention.

FIG. 10 is an exemplary coefficient gene according to the invention.

FIG. 11 is an exemplary block diagram of a method showing the functionality of the temporal gene according to the invention.

### DETAILED DESCRIPTION

Embodiments of the invention will be described with reference to the accompanying drawing figures wherein like numbers represent like elements throughout. Further, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The invention is not limited to any particular software language described or implied in the figures. The preferred language is JAVA. However, a variety of alternative software languages may be used for implementation of the invention.

For business purposes, a genetic algorithm is implemented and predictive models are encoded into chromosomes that may be manipulated by the genetic algorithm and back to a predictive model. The predictive model may be thought of as the equation for the genetic algorithm, and the genetic algorithm evolves the equation. Embodiments of the invention provide a temporal gene for use in genetic algorithm business applications.

Genes represent discrete components of a problem solution (chromosome) that can vary independently of each other throughout the evolution process. A gene can be defined as the encoding of a single parameter in a genetic algorithm and may take many forms depending on the problem definition.

The genetic algorithm encoding process uses a set of genes grouped together forming a chromosome to describe a predictive model. Each gene describes a piece of the predictive model and appears as a binary bit string that may be decoded and encoded during an evolution epoch. Genes are typically represented as sequences of 1's and 0's which introduces a layer of complexity as a translation is needed between the actual values of parameters, for example, a decimal number and age, and their binary representation.

Configuring genes as objects in Java makes the implementation more intuitive and may be extended to make them reusable across different genetic algorithm implementations. Each object may be viewed as an independent machine with a distinct function. Objects act on each other, as opposed to a traditional view in which a program may be seen as a collection of functions, or simply as a list of computer instructions. Each object is capable of receiving data, processing data, and sending data to other objects.

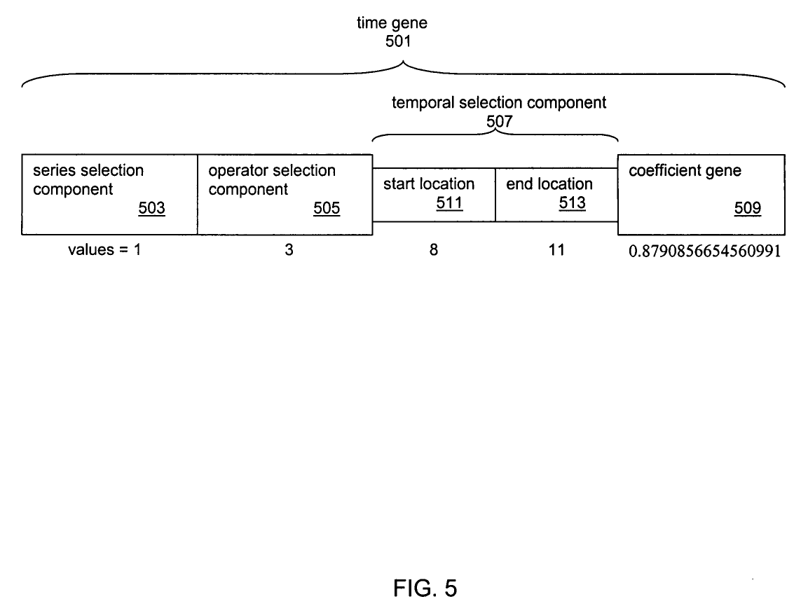

Shown in FIG. 5 is the architecture of a temporal, or time series gene 501 according to the invention. The time series gene 501 encodes temporal behavior for modeling purposes as a binary string and allows a genetic algorithm to explore the temporal relationship of a variable through the use of time series interactions. A time series interaction examines a specific variable at specific moments in time. A chromosome containing a temporal gene 501 may be evolved like other chromosomes in the genetic algorithm. The time series gene 501 describes a segment of the whole predictive model, and using temporal interactions, improves the performance of the predictive model.

The time series gene 501 creates time series interactions. A time series gene 501 comprises a series selection component 503, an operator selection component 505, a temporal selection component 507 and a coefficient gene 509. The series selection component 503 identifies which series of variables to interact with. The operator selection component 505 identifies which operator, from a predefined list of operators, is used when performing the interaction. The temporal selection component provides a start 511 and an end 513 location in the series 503 variables. The coefficient gene 509 contains a predetermined value that may change with the other time series gene components 503, 505, 511, 513 during evolution.

The coefficient gene 509 has an associated mutate method which alters its state as part of the evolutionary process. Time genes 501 also have an associated mutate method. The time series gene 501 mutating method summons the mutate method of the coefficient gene 509 in addition to mutating the series selection 503, operator selection 505 and temporal selection 507 components.

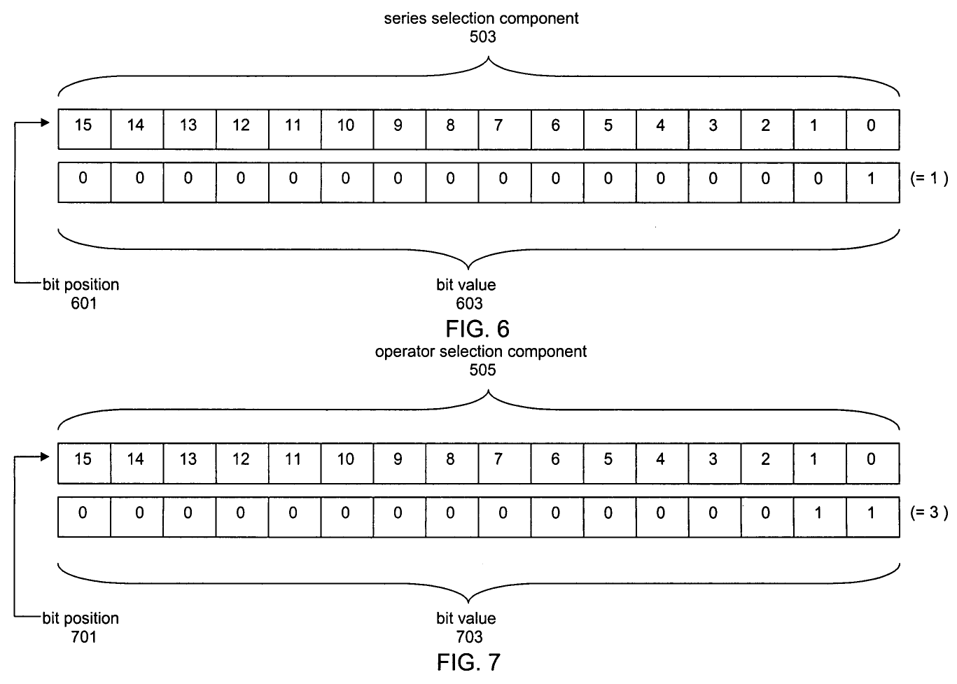

The series selection component 503 is shown in FIG. 6 and determines which series of variables from the dataset the gene 501 will be interacting with using a 16-bit integer 601, 603 to select the series. For example, a variable account_balance_{—}0 may be a continuous variable representing an individual's savings account balance at the end of month 0, 0 representing January. Variables account_balance_{—}1 through account_balance_{—}11 may represent the individual's account balance at the ends of the next eleven months—February through December. A genetic algorithm may find relationships between each of the twelve variables and yield a more accurate prediction of future behavior.

A complete time series interaction of the temporal gene 501 Java object is illustrated in the following pseudo-code:

series_{—}1=operator sel (series sel (start loc, end loc))*coef gene;

SCORE=SCORE+series_{—}1;

inserting exemplary time gene 501 component values,

series_{—}1=MIN(account_balance_{—}08, account_balance_{—}09, account_balance_{—}10, account_balance_{—11})*0.8790856654560991;

SCORE=SCORE+series_{—}1.

When the code is applied to an observation, or a single record in the dataset, the operator 505 chosen is a minimum function and finds the minimum of a subset of the variables in the account_balance series, namely account_balance_{—}08 (511) through account_balance_{—}11 (513), or, account_balance_{—}08, account_balance_{—}09, account_balance_{—}10 and account_balance_{—}11. The raw, minimum value returned is multiplied by the coefficient gene 509 value, 0.8790856654560991. An overall score SCORE of the predictive model is incremented by the value of series_{—}1. The account_balance series is a collection of all variables whose names start with the string “account_balance_” or account_balance_{—}00-account_balance_{—}11.

The overall SCORE of the predictive model is incremented by the value of series_{—}1. The holder variable, series_{—}1, as defined above, is modified based on the above logic. The score variable is defined at the beginning of the entire predictive model and is modified by every active gene group that has an include/exclude gene set to include that gene group.

An include/exclude gene performs binary encoding for feature subset selection. Typically, there is an include/exclude gene associated with every gene group. Include/exclude genes determine which individual variables and interactions encoded in the chromosome should be part of the predictive model. There may be several time series genes 501 in a chromosome, correspondingly several temporal interactions can be present in the predictive model described by the chromosome. This may be accomplished by having include/exclude genes determining if each time series gene 501 should be a part of the predictive model. An include/exclude gene can be mutated like any other gene and in the process of mutation, change the gene group it is part of from being included in the predictive model, to being exclude, or the reverse.

In the above example, the value of the series selection component 503 of the time series gene 501 is 1 and maps to the account_balance series which contains variables from the dataset that includes the account_balance variables. The account_balance variables include variables account_balance_{—}00 through account_balance_{—}11. Each variable in the dataset may optionally be assigned to a series.

The greater the value of the minimum of account_balance_{—}08 through account_balance_{—}11 the time series gene is predicting that the observation is more likely to be a responder in the predictive model because of the positive value of the coefficient that is multiplied by the large minimum value. However, the lesser the value of the minimum, the time series gene is predicting that the observation is less likely to be a responder in the predictive model because of the positive value of the coefficient that is multiplied by the small minimum value. A responder is an observation in the dataset with a dependent variable value of 1. If the time series gene proves to be able to accurately predict the value of the dependent variable, the greater the value that is returned indicates that the observation will most likely be a responder.

The assignment of a variable to a series is defined in the metadata that describes a dataset. The metadata stores each of the series that have been defined and the list of variables that have been assigned to each series. A variable may be assigned to only one series at a time. The process by which series are created and have variables assigned to them may be performed in one of two ways. First, a user of the GA program may manually create a series, and assign variables to it updating the metadata that describes the dataset. Or, the program may analyze the dataset and create a series for each set of variables that start with the same prefix. For example, account_balance_{—}00 and account_balance_{—}01 both start with the prefix account_balance_. Each of these variables may be programmatically assigned to the same series changing the metadata description of the dataset.

The set of all variables assigned to a series are considered the same variable observed at different points in time. For example, all of the variables, account_balance_{—}00 to account_balance_{—}11, are the same variable (in a person's account balance) observed at different times. Each series in the dataset may be assigned an integer value, starting at 0 and incremented as each new series is created. The series selection component 503 chooses a series and the operator selection component 505 determines how the series of variables interact.

In the above example, the time series gene 501 is searching for the minimum value of account_balance_{—}08 through account_balance_{—}11, a subset of the account_balance variables. The temporal gene 501 uses a predefined number of operators that may be referenced using an index value. The numerical index cross reference for each specific operator does not change during evolution. However, the operator selection component 505 used in the time series gene interaction may change during evolution and map to the same or a different operator.

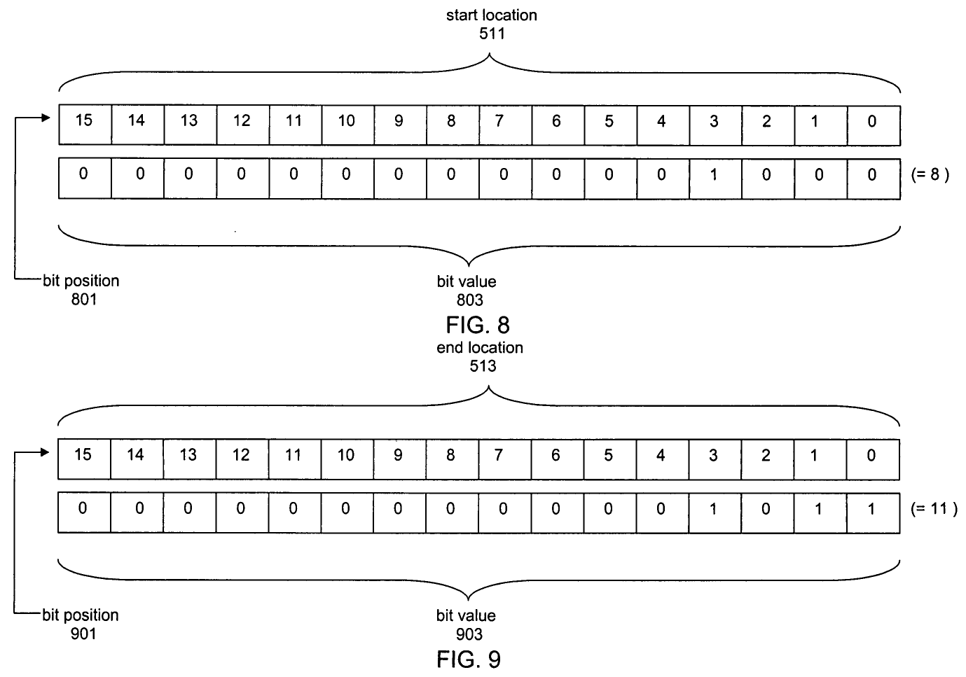

The operator selection component 505 is shown in FIG. 7 and is a 16-bit integer value 701, 703 that selects an operator from a predefined library. Examples of time series operators are slope, predicted error, minimum, minimum index, maximum, maximum index, and average. In the above example, operator value of 3 corresponds to a minimum function.

The slope operator computes the slope of a line between the start and end variables. The predicted error operator is similar to the slope operator, except that it computes a line between the starting variable and the variable immediately before the ending variable. This line is used to predict the ending variable. The output of this operation is the difference between the predicted value of the ending variable and the actual value of the ending variable. The minimum operator returns the minimum value of the variables used in the interaction for the observation. The maximum operator returns the maximum value of the variables used in the interaction for an observation. The minimum index operator returns the time period index in which the minimum value acquired of the variables used in the interaction for the observation. The maximum index operator returns the time period in which the maximum value acquired of all the variables used in the interaction for the observation. The average operator returns an average value of all the variables used in the interaction for the observation. Not every variable that is assigned to the selected series will be used in an interaction, only variables used in an interaction. The start 511 and end 513 location of the temporal selection component defines the subset of variables used in the interaction.

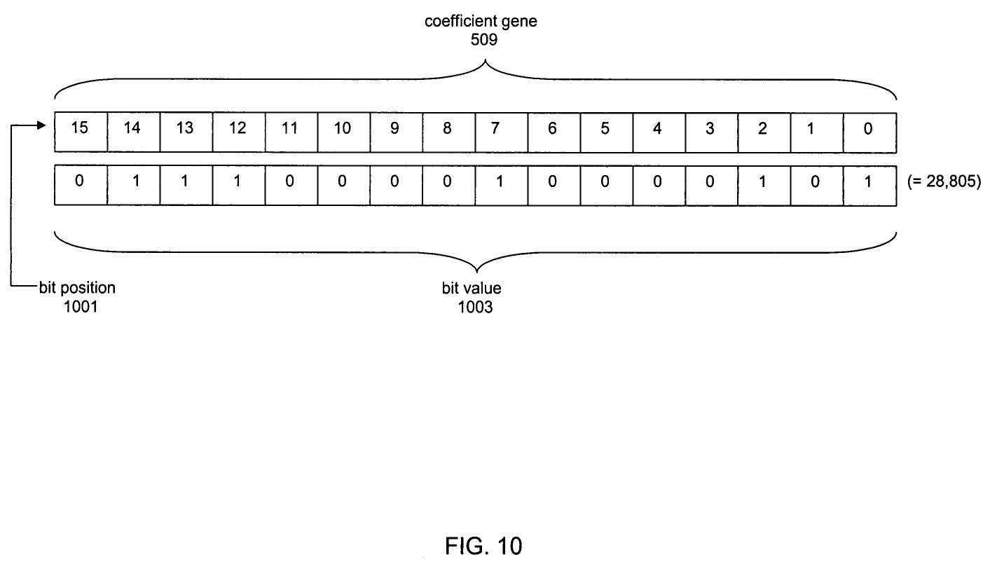

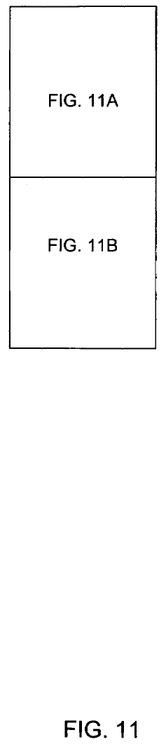

In the example, the time series gene 501 is interacting with the account_balance variables by finding the minimum value of a subset of those variables. The temporal selection component 507 defines the subset and is comprised of two 16-bit integer values 511, 513 shown in FIGS. 8 and 9 which indicate a start 801, 803 and an end point 901, 903 in the selected series 503 of variables. The temporal ordering of the variables 511, 513 is determined by the alphabetical ordering of the variable names. other ordering methods may be used. In the example, the subset starts at the ninth variable, account_balance_{—}08, and ends at the twelfth variable, account_balance_{—}11.

The coefficient gene 509 value is a weighting factor that multiplies the result of applying the operator 505 to the variables selected 503 in the series and is used to adjust the impact of the gene on the predictive model. The value returned by the temporal gene 501 logic is adjusted by the coefficient gene 509. The coefficient gene 509 weights the series_{—}1 result.

The coefficient gene 509 include a value and logic that enables the coefficient gene to convert the value between a floating-point number and binary string, and mutate the value by changing random bits in its binary string. The coefficient gene 509 obviates statistical estimation methods by embedding a coefficient into a gene. Embedding a coefficient allows the coefficient used in a predictive model to be evolved by a GA rather than needing to use a statistical estimation method. The coefficient gene 509 is evolved and may undergo random mutation. All possible values of a coefficient gene are valid.

Time series genes 501 are initially created using randomly generated values. The series selection component 503 is given a random initial value between zero and the total number of series in the dataset which is predefined. The operator selection component 505 is given a random initial value between zero and the total number of operators which is predefined. The temporal selection components 511, 513 are given random initial values as well.

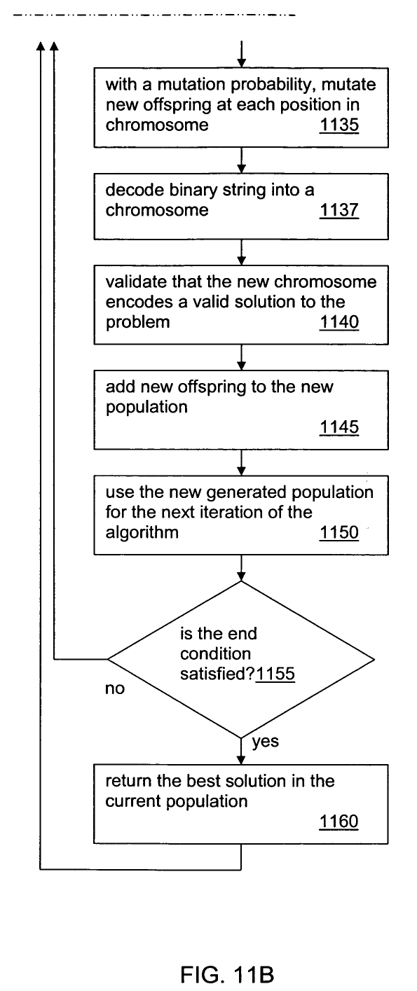

The start location 511 is given an initial value between zero and one less than the total number of variables in the in the selected dataset. The end location 513 is given an initial value between one and the total number of variables in the selected series 503. In the account balance example, there are 12 variables in the series account_balance_{—}00 through account_balance_{—}11. The start location may have a value between 0 and 10 and the end location may have a value between 1 and 11 (11 is the index of the 12^{th} variable, 0 is the index of the 1^{st}) If the end location 513 has a value less than or equal to the start location 511, the end location 513 value is adjusted to have a value of the start location 511 plus one. If the time series gene is initially created such that the start location is given a value of 5 and the end location is given a value of 3, the end value is adjusted to 5+1 or 6 so that it is greater than the start position. This process is also performed during validation (step 1140 shown in FIG. 11) to ensure that the start location is less than the end location. The coefficient gene 509 is randomly initialized with a value between −1 and 1. Initialization pertains to how the gene is created, and more particularly, to assigning the coefficient gene 509.

The integer used for the series selection component 503, the operator selection component 505, and the start 511 and end 513 locations of the temporal selection component 505 are converted to a 16-bit binary string using standard decimal to binary conversion.

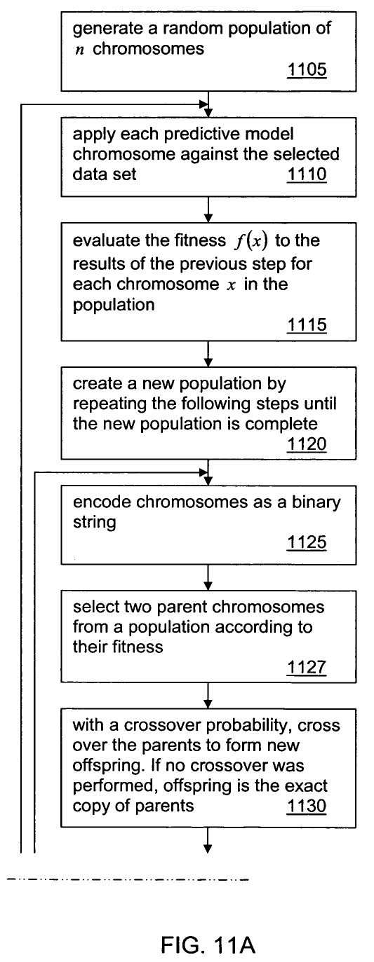

The coefficient gene 509 used in the exemplary embodiment may be a 16-bit integer 1001, 1003 as shown in FIG. 10. The 16-bit integer has a minimum value of −2's (−32, 768) and a maximum value of 2¹⁵−1 (32, 767). Bits 14-0 are used to store the value of the number and bit 15 is used to indicate sign (±). Prior to mutation, the 16-bit integer is converted into a 16-bit binary string. When a coefficient gene 509 is used in an equation, the value of the 16-bit integer is divided by 2¹⁵−1, returning a value between −1 and 1. The operation normalizes the coefficient value. However, any range between −32, 768 and 32, 767 may be specified.

Genes work together in groups to perform a large part of a predictive model. For example, one such gene, an include/exclude gene (not shown) is responsible to determine if a specific variable treatment or interaction should be used in the model. If this gene is included, other genes manipulate the data. An include/exclude gene may mark a time gene as an active part of the predictive model.

To encode a binary string from the integer numbers that describe a time gene 503, the 16-bit series selection component 503 binary string is created, followed by the 16-bit operator selection component 505 binary string which is appended to the end of the series selection component 503 binary string. The two 16-bit binary strings that describe the start 511 and end 513 locations of the temporal selection component 507 are appended to the end of the operator selection component 505 binary string followed by the binary string describing the coefficient gene 509 which is appended to the end.

To decode the binary string after evolution into integer numbers, the series selection component 503 is created using binary conversion from the first 16 bits of the binary string. As each component is created, the bits that are used are removed from the string. The next 16 bits are read from the front of the binary string and are used to create the operator selection component 505. The next 32 bits are read and converted to two integers to create the start 511 and end 513 components of the temporal selection component 507. A coefficient gene 509 is created using the remaining bits of the binary string.

The series selection 503, operator selection 505 and temporal selection 507 components and coefficient gene 509 are passed through the evolutionary process and are subject to crossover and mutation as part of the larger chromosome. Due to crossover and mutation, the binary string may change during a subsequent epoch.

If during a preceding epoch the value of the operator selection component 505 was 3, it may change to 8 (0000000000001000). After an evolution epoch, the operator selection component 505 may apply a different operator. If the value of 3 indexed to a MIN function, the value of 8 may be a different operator such as SLOPE. The time gene 501 would therefore interact the SLOPE function with account_balance_{—}08 (511)—account_balance_{—}11 (513) assuming the temporal selection component 507 did not change during the subsequent epoch.

An undefined situation may occur during evolution. For example, there may be a total of 8 operators available, but after evolution, an operator selection component 505 value may become 16. The value would be out of range, attempting to interact the temporal selection component 507 with a non-existent operator 505.

To ensure that the components have not been mutated in such a manner to make the gene 501 unusable, after evolution, the component values must be validated. The series selection 503, operator selection 505 and temporal selection 507 components are validated, making sure that each value maps to a valid value.

Validation may be performed by taking the modulus of the component 503, 505, 507 values and the total number of series, operators and ranges, respectively, in the dataset. This ensures that the components always refer to a valid value. For example, the value of the operator selection component 505 is adjusted to the modulo of itself and the total number of operators. The values of the start 511 and end 513 locations of the temporal selection components 507 are adjusted to the modulus of themselves and the total number of variables in the series. An additional step is performed to ensure that the value of the start location 511 is less than the value of the end location 513 and that the end location 513 has a value greater than 1.

The series selection 503, operator selection 505 and temporal selection 507 components may return with values outside of their predetermined ranges. The invention 501 applies modular arithmetic to the components after an evolution epoch. For example, if a series selection component 503 returned with a value of 41, and there were only 30 series in a dataset, 41mod30=11. The result would be to interact the eleventh series in the dataset. Applying modular arithmetic does not affect components 503, 505, 507 that hold valid values. For example, if the total number of series is 30, and a series selection component 503 value after an evolution epoch was 13, 13mod30=13. Similar processes are used for the operator selection 505 and temporal selection components 511, 513.

When validating the operator selection component 505, the value of the operator selection component 505 is subjected to a modulo operation using the total number of available operators. When validating the temporal selection component 507, the values of the start 511 and end 513 location are subject to the modulo operation using the total number of variables in the select series. Additionally, the values of the start and end location are validated to insure that the end location is greater than the start location.

FIG. 11 shows a method of the invention. Each chromosome contains the elements of a predictive model that must be evaluated to determine how well that model predicts values for the dependent variable in the dataset referred to as fitness evaluation. A time series gene 501 is converted into part of a predictive model (steps 1105, 1110). Fitness evaluation develops a value for a user specified fitness metric.

The fitness metric selected by the user may be percent correctly classified that can be used with a categorical dependent variable, a linear correlation which can be used with a continuous dependent variable, or an upper lift which is a fitness measure based on only the top quintiles of a generation.

Fitness evaluation applies the chromosome model to each observation in the dataset to determine a predicted value for the dependent variable. Fitness evaluation compares the predicted and actual values for each observation and develops a single fitness metric that represents how well the predicted and actual values match across all observations in the training dataset (step 1115).

After chromosomes in the initial generation have been evaluated and assigned a fitness metric, a genetic algorithm is used in a computer to create the next generation of chromosomes. The genetic algorithm (step 1120) involves the steps of selection (step 1127), crossover (step 1130), and mutation (step 1135) and illustrates the process of the invention to create an initial generation and successive generations.

Selection (step 1127) identifies chromosomes in the initial generation which will be used to create the next generation of chromosomes. The selection of chromosomes is random. Each chromosome in the initial generation is represented by a weighted value that increases the chance of selection in proportion to the fitness metric.

Crossover (step 1130) is to produce candidate chromosomes for the next generation. The parameters which have been selected specify the target number of chromosomes in each generation and a virus rate. The virus rate determines the number of chromosomes (target number times the virus rate) in each generation that are created with a random process. Chromosomes introduced by the virus rate are not the result of selection, crossover, or any consideration of fitness.

A chromosome selected for breeding can be used in one of two ways—cloning or pure (standard) crossover. A crossover rate may be set by the user to control the proportion used for each type of crossover. For example, a 70% crossover rate means 70% of selected chromosomes are used to create offspring through a crossover process and the remaining 30% are used for simple cloning. The cloning process creates a chromosome for the new generation that is a duplicate of a chromosome selected from the current generation.

The crossover process creates two offspring chromosomes for the next generation based on two selected parent chromosomes. The process uses genes from each parent to create each of the offspring chromosomes.

A user controls the crossover process by specifying a number of crossover points, or selecting a uniform crossover process. When one specifies a number of crossover points, the system of the invention places each point at a random location in the chromosome. The crossover points define blocks of genes that are exchanged to create an offspring.

The crossover process creates an offspring by taking genes from one parent up to the first crossover, and taking genes from the other parent between the first and second crossover points. Genes from the first parent are taken between the second and third crossover points. This alternating process can continue for any number of crossover points.

The uniform crossover process uses every possible point in a chromosome as a crossover point. Instead of alternating the use of gene blocks, the system uses a random process to determine if genes from the other parent will be used for the next block. For a chromosome with many genes, crossover (using a gene from the other parent) occurs at half the eligible crossover points.

Crossover points can occur at any point in a variable gene segment. For any variable, a child can have an include/exclude gene from one parent and a coefficient gene from the other parent. The active variables in a child chromosome (created with crossover) must be active in one of the parents but the overall set of active variables will likely be different from either parent.

The chromosomes created by breeding (cloning and crossover) are considered candidates for the next generation and are subjected to mutation. The temporal gene 501 is part of a whole chromosome and is converted into a binary string.

Mutation is a random process that reverses selected bits in the candidate chromosomes based on the probability value entered as the mutation rate (step 1135). During mutation, bits are randomly flipped within the chromosomes in order to insure diversity within a generation. After mutation, the mutated temporal gene 501 is validated (step 1140).

As mentioned above, the virus rate determines the number of chromosomes created with a random process. The system uses a random process to create the number of chromosomes that equals the virus rate applied to the desired population size. The remaining chromosomes in the generation are created through crossover. Because the chromosomes introduced by the virus rate are created without regard to fitness measures or any other characteristic of the current generation, they tend to introduce diversity into a new generation that explores new areas of a search space. Increasing the virus rate tends to explore new areas while decreasing the rate tends to fine tune the best models already attained.

After the next generation has been created, each chromosome in the next generation has its fitness evaluated as before (steps 1145, 1150, 1155, 1110, 1115-1160). Following the fitness evaluation, the genetic algorithm is applied to the next generation of chromosomes as discussed above to create a new generation of chromosomes. The iterative process of chromosome creation, evaluation, and next generation chromosome creation continues until the user stops the process.

One or more embodiments of the present invention have been described. Nevertheless, it will be understood that various modifications may be made without departing from the spirit and scope of the invention. Accordingly, other embodiments are within the scope of the following claims.

What is claimed is:

1. A temporal gene for use in a chromosome of a genetic algorithm comprising:
a series selection component for determining which series from a dataset will interact;
a temporal selection component for determining a start location value and an end location value that map to variables in said selected series; and
an operator selection component for determining which operator from a predefined list of operators will be used to interact with variables from said start location value to said end location value, wherein the temporal gene returns a result from said interaction between said operator and said variables from said start to said end locations.

2. The temporal gene according to claim 1 wherein said series selection component, said operator selection component, and said temporal selection component experience evolution.

3. The temporal gene according to claim 2 wherein said series selection component, said operator selection component, and said temporal selection component are encoded as binary numbers from integer numbers prior to evolution.

4. The temporal gene according to claim 3 wherein said operator selection component value corresponds to an indexed library of functions.

5. The temporal gene according to claim 4 wherein said operator selection component value corresponds to one of a slope, a predicted error, a minimum, a minimum index, a maximum, a maximum index, and an average function.

6. The temporal gene according to claim 5 further comprising a coefficient gene for holding a predetermined value.

7. The temporal gene according to claim 6 wherein said predetermined value is used as a multiplier for another gene.

8. The temporal gene according to claim 6 wherein said predetermined value is an output of another gene.

9. The temporal gene according to claim 6 wherein said predetermined value is a weighting factor.

10. The temporal gene according to claim 6 wherein said coefficient gene value is multiplied with said result.

11. The temporal gene according to claim 10 wherein said coefficient gene is encoded as a binary number from an integer number prior to evolution.

12. The temporal gene according to claim 11 wherein said series selection component, said operator selection component, said temporal selection component and said coefficient gene are decoded to integer numbers from binary numbers after evolution.

13. The temporal gene according to claim 12 wherein modular arithmetic is applied to said series selection component, said operator selection component and said temporal selection component after evolution to validate that the evolved values of said series selection component, said operator selection component and said temporal selection component are each within a respective predetermined range of variable values.

14. A method of creating temporal interactions for use in a genetic algorithm as a temporal gene comprising:
providing a series selection component for determining which series from a dataset will interact;
providing a temporal selection component for determining a start location value and an end location value that map to variables in said selected series; and
providing an operator selection component for determining which operator from a predefined list of operators will be used to interact with variables from said start location value to said end location value, wherein the temporal gene returns a result from said interaction between said operator and said variables from said start to said end locations.

15. The method according to claim 14 further comprising evolving said series selection component, said operator selection component and said temporal selection component.

16. The method according to claim 15 further comprising encoding said series selection component, said operator selection component and said temporal selection component as binary numbers from integer numbers prior to evolving.

17. The method according to claim 16 wherein encoding further comprises concatenating said series selection component binary number with said operator selection component binary number and with said temporal selection component binary number.

18. The method according to claim 16 further comprising providing a coefficient gene for holding a predetermined value.

19. The method according to claim 18 wherein said predetermined value is used as a multiplier for another gene.

20. The method according to claim 18 wherein said predetermined value is an output of another gene.

21. The method according to claim 18 wherein said predetermined value is a weighting factor.

22. The method according to claim 18 further comprising multiplying said coefficient gene value with said result.

23. The method according to claim 22 further comprising encoding said coefficient gene as a binary number from an integer number prior to evolution.

24. The method according to claim 23 further comprising decoding said series selection component, said operator selection component, said temporal selection component and said coefficient gene to integer numbers from binary numbers after evolving.

25. The method according to claim 24 further comprising:
creating an integer number for said series selection component from a number of bits corresponding to the number of bits used to form its binary number;
creating an integer number for said operator selection component from a number of bits corresponding to the number of bits used to form its binary number;
creating integer numbers for said temporal selection component start location and end location from a number of bits corresponding to the number of bits used to form its binary numbers; and
creating an integer number for said coefficient gene from a number of bits corresponding to the number of bits used to form its binary number.

26. The method according to claim 25 further comprising applying modular arithmetic to said series selection component, said operator selection component and said temporal selection component after evolving for validating that the evolved values of said series selection component, said operator selection component and said temporal selection component are each within a respective predetermined range of variable values.

27. The method according to claim 26 further comprising assembling a logic statement for the temporal gene from said start and end locations defined by said temporal selection component and said operator selection component, wherein said logic statement provides said result.

28. A method of creating temporal interactions for use in a genetic algorithm as a time gene comprising:
providing a series selection component for determining which series from a dataset will interact;
providing a temporal selection component for determining a start location value and an end location value that map to variables in said selected series;
providing an operator selection component for determining which operator from a predefined list of operators will be used to interact with variables from said start location value to said end location value,
providing a coefficient gene for holding a predetermined value;
assembling a logic for returning a result from said selected operator and said temporal selection component start and end location values; and
multiplying said predetermined value with said result.
